(19) United States
(12) Patent Application Publication
(10) Pub. No.: US 2006/0155830 A1
(43) Pub. Date: Jul. 13, 2006

(54) Configuration mediator for a multi-component software solution environment

(75) Inventors: Richard D. Dettinger, Rochester, MN (US); Daniel P. Kolz, Rochester, MN (US); Richard J. Stevens, Rochester, MN (US); Jeffrey W. Tenner, Rochester, MN (US)

Correspondence Address: William J. McGinnis;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/988,224

(22) Filed: Nov. 12, 2004

(51) Int. Cl. G06F 15/177; G06F 15/173

(52) U.S. Cl. 709/220; 709/223

(57) ABSTRACT

Method, computer readable medium and computer system are provided for coordinating configuration changes among components in a multi-component environment. In one embodiment, a method for changing a configuration of a component in a multi-component environment is provided, the method comprising: receiving a configuration change request for the component; accessing a set of mediation rules which define component relationships in the multi-component environment; based on the received configuration change request and the mediation rules, determining whether one or more corresponding configuration changes are warranted in one or more other components in the multi-component environment; and if the one or more corresponding configuration changes are warranted, sending one or more configuration change notifications to the one or more other components; receiving one or more responses from the one or more other components regarding the one or more configuration change notifications; and sending a configuration change response to the component based on the one or more responses received from the one or more other components.

### BACKGROUND OF THE INVENTION

1. Field of the Invention

The invention relates to coordinating configuration changes of a component in a multi-component environment. More particularly, the invention relates to a method for changing the configuration of one component in a multi-component environment and coordinating corresponding configuration changes for other components in the multi-component environment.

2. Description of the Related Art

In current computer systems, several software components may work together to perform one or more related tasks, with each component performing a portion of the task. These components may be considered together as a multi-component system. Typically, the individual components may be bundled together as a multi-component system or alternatively, purchased individually and combined by an administrator into a customized multi-component system.

Typically, for a multi-component system to function properly, each component must be configured to work with each of the other components. These configurations allow the components to share data and system resources. For the multi-component system to perform in an optimal manner, each of the component configurations may be selected with a view not only to basic functionality of the system as a whole, but with a view to optimal system performance. Whether a given set of configurations is optimal may turn on the nature of the components in the multi-component system, the nature of the task to be performed, or the available resources of the underlying computer system on which the multi-component system resides.

Currently, an administrator has few attractive choices when selecting configurations that are both functional and optimal in a multi-component system. Typically, upon installation of the multi-component system, the administrator is presented with several preset configurations chosen by the creator of the installation program. The preset configurations may be undesirable for several reasons. For example, the preset configurations may be suboptimal because the configurations do not use all of the available resources of the computer system. Also, the conditions under which the multi-component system is operating may change at some point after installation, rendering the original configurations suboptimal.

Suboptimal or nonfunctional configurations may also arise when the administrator attempts to add a new component to an existing multi-component system. The configuration of the new component may cause the system to perform suboptimally because the component fails to use all of the available system resources. The configuration of the new component may also be incompatible with other component configurations and may cause the component itself or other components not to function within the system. Finally, the configuration of the component may interfere and be incompatible with the configurations of other components and cause failure of the system as a whole.

In response to suboptimal performance, the administrator may decide to accept a suboptimal multi-component system in which some of the components are possibly non-functioning. The administrator may also attempt to remedy the problem by changing the individual component configurations of the components to achieve optimal performance. An attempt by the administrator to change individual component configurations may lead to further problems if the administrator chooses a configuration for one component that is incompatible with the configuration of another component. Such configuration changes may result in suboptimal performance (best-case), nonfunctioning of some of the components, or complete failure of the multi-component system (worst-case). Incompatible configuration changes in components may also arise automatically, without action by the administrator. Such configuration changes may arise in response to runtime properties of the system such as a change in buffer size, a change in the number of users, or a transaction rate.

To remedy problems associated with the configuration change of one component, the administrator may attempt to change manually the configurations of the other components to be compatible with the configuration change of the first component. The administrator may also undo the change and revert to one of the sub-optimal preset configurations provided for by the creator of the installation program, or the administrator may uninstall any component which is causing the system not to function or to function in a suboptimal manner.

Accordingly, coordination of configuration changes in a multi-component system such that the system is both functional and performs optimally is a daunting task. Furthermore, the complexity of the task and the pitfalls associated with configuration changes multiply as the number of components in the multi-component system increases. Thus, there is a need for simplifying the process of coordinating configuration changes among components in a multi-component environment. More particularly, there is a need to ensure that changes made to the configuration of one component are automatically propagated to another related component without the need for administrator intervention.

### SUMMARY OF THE INVENTION

Embodiments of the invention provide a method, computer readable medium, and computer system for coordinating configuration changes among components in a multi-component system. More particularly, embodiments of the invention ensure that changes made to the configuration of one component are automatically propagated to another related component without the need for administrator intervention. One embodiment provides a mediation component (also referred to herein as a configuration mediator) which works with a set of extensible rule that define relationships between individual component configurations that need to be maintained. The mediation component coordinates configuration changes across a set of software components that interact with one another or are influenced by the configuration changes in one or more peer components within an overall solution. The mediation component ensures that changes to one component are coordinated with changes in other components to keep the solution working in an optimal fashion, even when the set of components are not designed with a singular configuration interface.

In one embodiment, a method for changing a configuration of a component in a multi-component environment is provided, the method comprising: receiving a configuration change request for the component; accessing a set of mediation rules which define component relationships in the multi-component environment; based on the received configuration change request and the mediation rules, determining whether one or more corresponding configuration changes are warranted in one or more other components in the multi-component environment; and if the one or more corresponding configuration changes are warranted, sending one or more configuration change notifications to the one or more other components; receiving one or more responses from the one or more other components regarding the one or more configuration change notifications; and sending a configuration change response to the component based on the one or more responses received from the one or more other components.

Another embodiment provides a computer readable medium containing a program which, when executed, performs an operation for changing a configuration of a component in a multi-component environment. Yet another embodiment provides a computer system for changing a configuration of a component in a multi-component environment.

### BRIEF DESCRIPTION OF THE DRAWINGS

So that the manner in which the above recited features, advantages and objects of the present invention are attained and may be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a computer system utilized to implement the present invention according to one embodiment of the invention;

FIG. 2 is a dataflow diagram illustrating a method for coordinating a configuration change request according to one embodiment of the invention;

FIG. 3 is a block diagram illustrating a software component adapted to be utilized with a configuration mediator according to one embodiment of the invention;

FIG. 4 is a flow diagram illustrating a method for coordinating configuration changes according to one embodiment of invention; and

FIG. 5 is a flow diagram illustrating a method for coordinating configuration changes according to another embodiment of the invention.

### DETAILED DESCRIPTION OF THE PREFERRED EMBODIMENTS

Embodiments of the invention provide a method, computer readable medium, and computer system for coordinating configuration changes for components in a multi-component environment. The coordination of configuration changes may be initiated when a configuration change request for a component is received. Upon receiving the request, a determination is made as to whether other configuration changes are needed in other components. If the other changes are needed, notifications are sent to the other components, responses regarding the notifications are received, and a response is sent to the requesting component based on the responses received from the other components.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

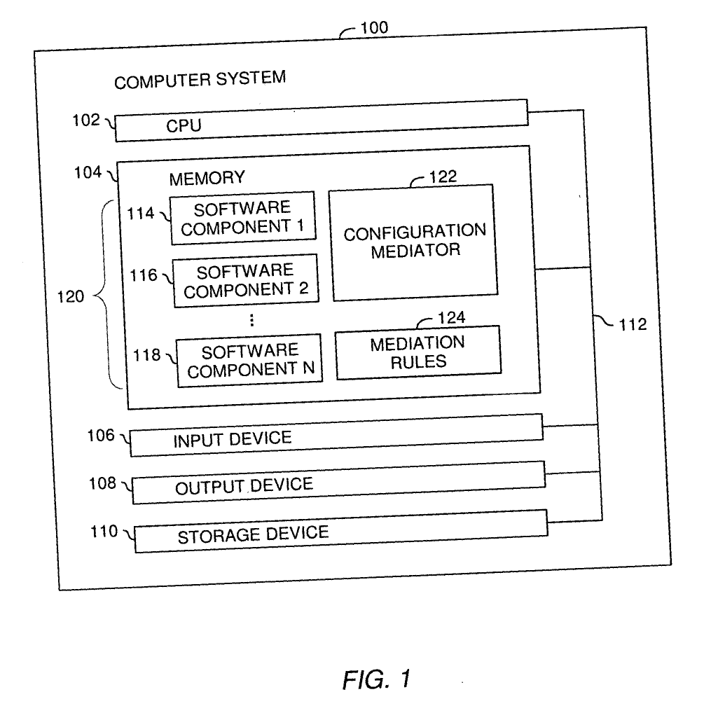

One embodiment of the invention is implemented as a program product for use with a computer system such as, for example, computer system 110 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

One embodiment of the invention provides a software program for use with associated programs and data in a computer system such as, for example, the computer system 100 shown in FIG. 1 and described below. The computer system 100 typically contains a central processing unit (CPU) 102 for executing the programs, a memory 104 for storing the programs and data during execution, an input device 106 and output device 108 for inputting and outputting data, a storage device 110 for long term storage of programs and data, and a system bus 112 which connects each of the components of the computer system 100. The programs and data contained in memory 104 may include a first software component 114, a second software component 116, and additional software components 118, which may be referred to collectively as the software components 120. The memory 104 may also include a configuration mediator 122 for interacting with the software components 120 and a data file containing mediation rules 124 which may be used by the configuration mediator 122 to coordinate configuration changes among the software components 120.

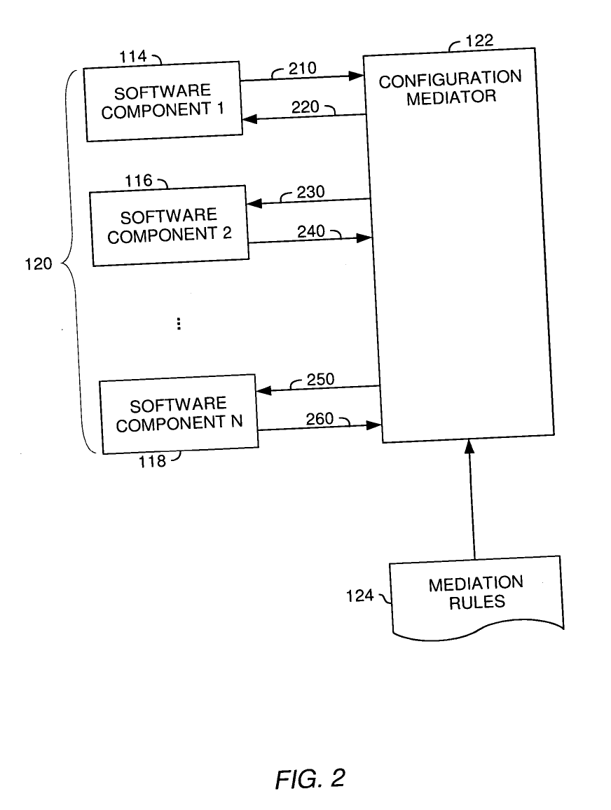

FIG. 2 shows a dataflow diagram illustrating a method for coordinating a configuration change request according to one embodiment of the invention. Each of the software components 120 may interact with the configuration mediator 122 by sending configuration change requests and configuration change notification responses to the configuration mediator 122 and by receiving configuration change notifications and configuration change responses from the configuration mediator 122.

In one embodiment, the method for coordinating configuration changes starts with a configuration change request 210 for the first software component 114 received by the configuration mediator 122. The configuration change request 210 may be initiated upon installation of a new component, installation of new hardware or functionality for the computer system 100, or upon a change in the functionality of an installed component. The configuration change request 210 may also be initiated in response to a user action or in response to a runtime property of the system. Further, the configuration change request 210 may be issued by the first software component 114 (as depicted), by any of the software components 120, by the configuration mediator 122, or by other processes located locally or remotely to the computer system 100.

In the case of a configuration change request 210 issued in response to a user action, the user action may be a request to install a feature in the multi-component system, a request to change an option of a component in the multi-component system, or the request may be issued automatically in response to the user attempting to access some functionality of the multi-component system. In the case of a configuration change request 210 issued in response to a runtime property of the system, the runtime property may, for example, include an increase in the workload of the system, such as a change in the number of users, a change in the number of components 120 or instances thereof, or a change in the transaction rate of the multi-component system or of one of the components 120 thereof.

After the configuration mediator 122 has received the configuration change request 210, the configuration mediator 122 may access the mediation rules 124 to determine whether to send a configuration change notification 230 to the second software component 116 and additional configuration change notifications 250 to the other software components 118. The second software component 116 and other components 118, after receiving notifications 230, 250, may send responses 240, 260 to the configuration change notifications 230, 250. Based on the responses 240, 260, the configuration mediator 122 may send a configuration change response 220 to the first software component 114. Upon receiving the configuration change response 220, the first software component 114 may make the appropriate configuration changes.

Illustratively, the configuration change notifications 230, 250 may be a mere notice of the change, allowing the components 116, 118 to make changes independently. Alternatively, the configuration change notifications 230, 250 may contain mediated configuration change requests specified by the mediation rules 124. These mediated configuration changes, to be carried out by the components 116, 118 receiving the notifications 230, 250, may be specified by the mediation rules 124.

The mediation rules 124 may specify that the mediated configuration changes are necessary for the system to continue functioning. Alternatively, the mediation rules 124 may specify that the mediated configuration changes are needed to optimize the functioning of the system. Contemplated mediated configuration changes include, for example, changing one component's setting as a function of another component's setting (e.g., set a buffer size of one component to twice the buffer size of another component), changing a setting for one component if a given feature of another component is enabled (e.g., set the buffer size of one component to 100 megabytes if the “extended file size” option of another component is enabled), changing a configuration setting for one component based on the overall multi-component system topology (e.g., increase the buffer size of one component by 10 megabytes for each instance that exists of another component), or changing a setting for one component based on a runtime property of the system, such as, the number of active users, a transaction rate, a data buffer size, or some other feature (e.g., the buffer size of one component should be incremented by 10 for each active user on the system).

Each of the above mediated configuration changes may be contained in the mediation rules 124. The mediation rules 124 may be provided in advance by the manufacturer of the multi-component system and may be extensible, allowing an administrator of the system to add and modify the individual rules. Furthermore, upon installation of a new component in the system, the new component may detect the presence of the other components 120, the configuration mediator 122, and/or the mediation rules 124 and accordingly add specialized mediation rules for the new component to the existing mediation rules 124.

In response to the configuration change notifications 230, 250 the components 116, 118 prepare responses 240, 260, respectively. Several types of responses are contemplated. The response may be a mere acknowledgement of the notification. The response may contain an acceptance or a rejection of the configuration change request, or an acceptance or a rejection of any mediated configuration changes requested in the notification. In addition, the response may contain information regarding the reason that the changes cannot be made or may contain alternative acceptable changes. For instance, if the notification 230 contains a meditated configuration change request to change a buffer size to 100 megabytes, the second component 116 may respond with a rejection of the mediated change and a suggestion that buffer values from 0 to 75 megabytes are acceptable. This information may then be used by the configuration mediator 122 and other software components 114, 118, or may be displayed to the user/administrator so that an acceptable configuration change may then be chosen. The components 120 may be designed to be “smart components” in the sense that they understand the system resources necessary for a level of configuration and respond to the configuration mediator 122 accordingly (e.g., the response 240 may state that for a buffer size of 100 megabytes the computer must have 256 megabytes of RAM, and this message may then be routed to the user/administrator).

Upon receiving the configuration notice responses 240, 260, the configuration mediator 122 may send a configuration change response 220 to the first software component 114. The configuration mediator 122 may also decide whether to allow the configuration change. If one or more of the components 116, 118 have rejected the initial configuration change request 210 relayed via the configuration change notifications 230, 250, or if a given mediated configuration change is necessary for proper system functioning and the change has been rejected, the configuration mediator 122 may send the response 220 as a rejection of the requested change 210. In such a case, the configuration mediator 122 may send with the response 220 a reconfiguration notification thus allowing the first component 114 to determine whether another configuration may be chosen.

In one embodiment of the invention, a mediated configuration change may be made solely for the purpose of optimization and may not be necessary for proper system functioning. If such a mediated change is rejected by one of the software components 116, 118, the original configuration change for the first component 114 may still be made without affecting proper system functioning. In the case where the system will continue to function without the mediated configuration changes, the configuration mediator may send an allowance of the original configuration change 220 to the first software component 114 and thus allow the system to continue performing, albeit without making the optimizing mediated configuration change. Alternatively, the configuration mediator 122 may choose to request another mediated configuration change, less optimal than the original requested change, or the user/administrator may be notified and prompted for feedback as to what course of action should be taken. Thus, the configuration mediator 122 may be considered to be fault tolerant and have the ability to choose the most optimal configuration changes possible for a given multi-component system.

The ordering of the requested configuration change and the mediated configuration changes may be determined in various ways. In one embodiment, each software component 116, 118, makes the mediated change, if possible, upon receiving a request for the change. If, at a later time, another component rejects a necessary meditated configuration change, the configuration mediator 122 may then roll-back any of the changes already made. If all mediated changes were accepted, the configuration change response 220 to the first component 114 may contain an acceptance of the configuration change request 210, and the first software component 114 may accordingly make the configuration change. Another contemplated embodiment may utilize two-phase commit semantics to coordinate configuration changes across the components 120, ensuring that either all components were able to make necessary configuration changes or that no changes were made.

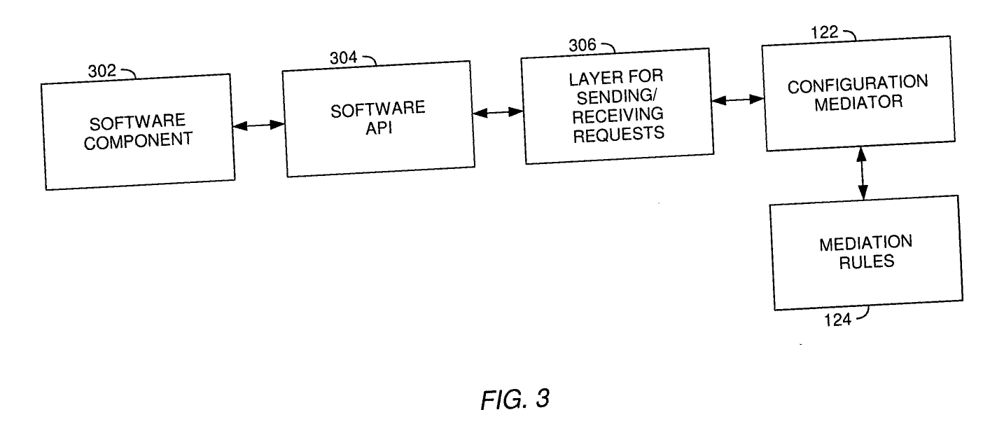

In one embodiment of the invention, the software components 120 are each specifically designed to interface with the configuration mediator 122. In another embodiment, an individual software component 302 may be adapted for use with the configuration mediator 122 as shown in FIG. 3. In such an embodiment, a software application program interface (API) 304 for the software component 302 may be used to create a layer 306 for sending and receiving any of the various types of requests. Additionally, upon installation, the software component 302 may detect and register with the configuration mediator 122, allowing for specialized mediation rules to be added to the general mediation rules file 124.

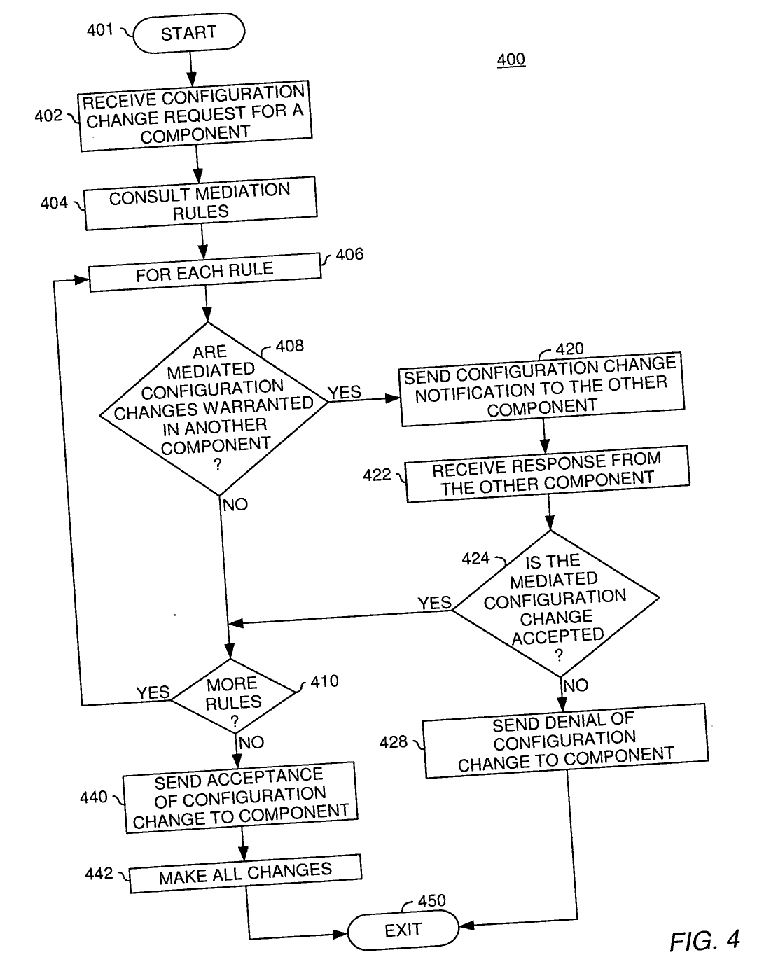

FIG. 4 is a flow diagram illustrating a method 400 for coordinating configuration changes according to one embodiment of invention. The method 400 begins at step 401, and at step 402, the configuration mediator 122 receives a request for a configuration change in a component. The mediation rules 124 are consulted at step 404, and the rules are examined in a loop starting at step 406. For each rule in the mediation rules 124, the method 400 determines whether mediated configuration changes are warranted in another component (step 408). If the specific rule shows that mediated configuration changes are not warranted, the loop starting at step 406 continues while there are rules remaining to be examined (as determined in step 410). However, if changes are warranted in another component, one or more configuration change notifications are sent to the other components (step 420), and the configuration mediator 122 waits for responses from the other components. After receiving responses from the other components at step 422, the method 400 determines whether the mediated configuration changes are accepted (step 424). If the mediated configuration changes are accepted at step 424, the loop starting at step 406 is continued while there are still rules to examine (as determined in step 410). If the mediated change is rejected at step 424, a rejection of the configuration change is sent to the requesting component at step 428, and the program terminates (or waits for another request) at step 450. However, if all of the changes warranted by the rules are accepted and no more rules remain to be examined, an acceptance of the configuration change is sent to the requesting component at step 440. All of the changes, requested and mediated, are effected at step 442, and the method exits at step 450.

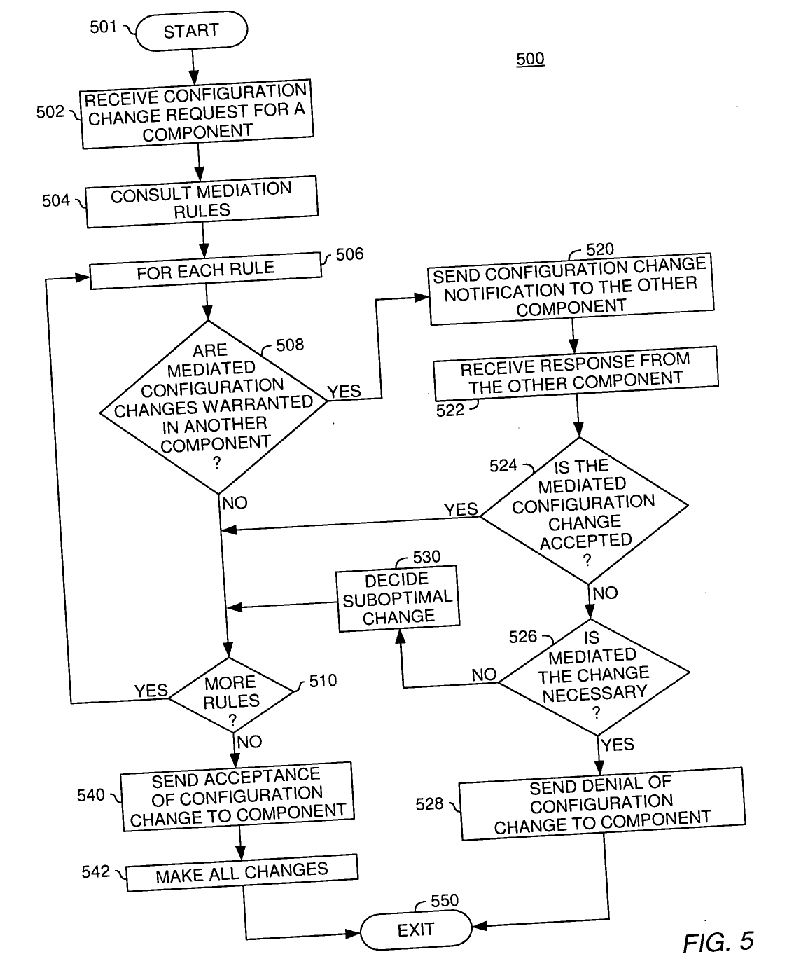

FIG. 5 is a flow diagram illustrating a method 500 for coordinating configuration changes according to another embodiment of the invention. The method 500 begins at step 501, and at step 502, the configuration mediator receives a request for a configuration change in a component. The mediation rules 124 are consulted at step 504, and the rules are examined in a loop starting at step 506. For each rule in the mediation rules 124, the method 500 determines whether mediated configuration changes are warranted in another component (step 508). If the rules show that mediated configuration changes are not warranted, the loop starting at step 506 continues while there are rules remaining to be examined (as determined in step 510). However, if changes are warranted in another component, one or more configuration change notifications are sent to the other components (step 520), and the configuration mediator 122 waits for responses from the other components. After receiving responses from the other components at step 522, the method 500 determines whether the mediated configuration changes are accepted (step 524). If the mediated configuration change is accepted at step 524, the loop starting at step 506 is continued while there are still rules to examine (as determined in step 510). However, if the mediated configuration change is rejected at step 524, the method 500 determines if the mediated change is necessary for proper system functioning (step 526). The mediated change may be unnecessary because it is merely for the purpose of optimization, thus the program may choose an available suboptimal change, if any (at step 530), and the loop starting at step 506 continues while there are rules to examine (as determined in step 510). If the mediated change is determined to be necessary at step 526, a rejection of the configuration change is sent to the requesting component at step 528, and the program terminates (or waits for another request) at step 550. However, if all of the changes warranted by the rules are accepted and no more rules remain to be examined, an acceptance of the configuration change is sent to the requesting component at step 540. All of the changes, requested and mediated, are effected at step 542, and the method exits at step 550.

While the foregoing is directed to embodiments of the present invention, other and further embodiments of the invention may be devised without departing from the basic scope thereof, and the scope thereof is determined by the claims that follow.

What is claimed is:

1. A computer-implemented method for changing a configuration of a component in a multi-component environment, comprising:
receiving a configuration change request for the component;
accessing a set of mediation rules which define component relationships in the multi-component environment;
based on the received configuration change request and the mediation rules, determining whether one or more corresponding configuration changes are warranted in one or more other components in the multi-component environment; and
if the one or more corresponding configuration changes are warranted,
sending one or more configuration change notifications to the one or more other components;
receiving one or more responses from the one or more other components regarding the one or more configuration change notifications; and
sending a configuration change response to the component based on the one or more responses received from the one or more other components.

2. The method of claim 1, wherein the component is configured to send the configuration change request automatically in response to a change in a runtime property of the multi-component environment.

3. The method of claim 1, wherein the configuration change request is received while installing the component into the multi-component environment and wherein the one or more other components have already been installed.

4. The method of claim 1, wherein the one or more configuration change notifications to the one or more other components contain one or more mediated configuration changes for the one or more other components.

5. The method of claim 4, wherein the one or more mediated configuration changes comprise a change which is dependent upon a runtime activity of the one or more other components.

6. The method of claim 5, wherein the runtime activity is one of a number of active users, a transaction rate, or a data buffer size.

7. The method of claim 1, wherein the one or more responses from the one or more other components regarding the one or more configuration change notifications comprise one of an acceptance of the configuration change and a rejection of the configuration change.

8. The method of claim 1, wherein the configuration change is made by the component based upon whether the configuration change response indicates an acceptance of the configuration change request by the one or more other components.

9. The method of claim 1, wherein the mediation rules comprise one or more mediated configuration changes to be made to the one or more other components, wherein each of the mediated configuration changes comprise one of a configuration change based on another component's configuration setting, a configuration change based on an enablement of another component's feature, and a configuration change based on a number of instances of another component.

10. The method of claim 1, further comprising:
when at least one other components rejects the configuration change request, generating a re-configuration request which includes a modification to the configuration change request; and
sending the re-configuration request to the component.

11. A computer readable medium containing a program which, when executed, performs an operation, comprising:
receiving a configuration change request for the component;
accessing a set of mediation rules which define component relationships in the multi-component environment;
based on the received configuration change request and the mediation rules, determining whether one or more corresponding configuration changes are warranted in one or more other components in the multi-component environment; and
if the one or more corresponding configuration changes are warranted,
sending one or more configuration change notifications to the one or more other components;
receiving one or more responses from the one or more other components regarding the one or more configuration change notifications; and
sending a configuration change response to the component based on the one or more responses received from the one or more other components.

12. The computer readable medium of claim 11, wherein the component is configured to send the configuration change request automatically in response to a change in a runtime property of the multi-component environment.

13. The computer readable medium of claim 11, wherein the configuration change request is received while installing the component into the multi-component environment and wherein the one or more other components have already been installed.

14. The computer readable medium of claim 11, wherein the one or more configuration change notifications to the one or more other components contain one or more mediated configuration changes for the one or more other components.

15. The computer readable medium of claim 14, wherein the one or more mediated configuration changes comprise a change which is dependent upon a runtime activity of the one or more other components.

16. The computer readable medium of claim 15, wherein the runtime activity is one of a number of active users, a transaction rate, or a data buffer size.

17. The computer readable medium of claim 11, wherein one or more responses from the one or more other components regarding the one or more configuration change notifications comprise one of an acceptance of the configuration change and a rejection of the configuration change.

18. The computer readable medium of claim 11, wherein the configuration change is made by the component based upon whether the configuration change response accepts or rejects the configuration change request.

19. The computer readable medium of claim 11, wherein the mediation rules comprise one or more mediated configuration changes to be made to the one or more other components, wherein each of the mediated configuration changes comprise one of a configuration change based on another component's configuration setting, a configuration change based on an enablement of another component's feature, and a configuration change based on a number of instances of another component.

20. The computer readable medium of claim 11, wherein the sending of a configuration change response to the component based on the one or more responses received from the one or more other components comprises sending a reconfiguration notification when the or more other components reject the configuration change.

21. A computer system comprising a processor and a memory for storing a plurality of components in a multi-component environment and a program, when executed by the processor, performing an operation for changing a configuration of a first component, the operation comprising:
receiving a configuration change request for the first component;
accessing a set of mediation rules which define component relationships in the multi-component environment;
based on the received configuration change request and the mediation rules, determining whether one or more corresponding configuration changes are warranted in one or more other components in the multi-component environment; and
if the one or more corresponding configuration changes are warranted,
sending one or more configuration change notifications to the one or more other components;
receiving one or more responses from the one or more other components regarding the one or more configuration change notifications; and
sending a configuration change response to the first component based on the one or more responses received from the one or more other components.

22. The computer system of claim 23, wherein the component is configured to send the configuration change request automatically in response to a change in a runtime property of the multi-component environment.

23. The computer system of claim 21, wherein the configuration change request is received while installing the component into the multi-component environment and wherein the one or more other components have already been installed.

24. The computer system of claim 21, wherein the one or more configuration change notifications to the one or more other components contain one or more mediated configuration changes for the one or more other components.

25. The computer system of claim 24, wherein the one or more mediated configuration changes comprise a change which is dependent upon a runtime activity of the one or more other components.

26. The computer system of claim 25, wherein the runtime activity is one of a number of active users, a transaction rate, or a data buffer size.

27. The computer system of claim 21, wherein one or more responses from the one or more other components regarding the one or more configuration change notifications comprise one of an acceptance of the configuration change and a rejection of the configuration change.

28. The computer system of claim 21, wherein the configuration change is made by the first component based upon whether the configuration change response accepts or rejects the configuration change request.

29. The computer system of claim 21, wherein the mediation rules comprise one or more mediated configuration changes to be made to the one or more other components, wherein each of the mediated configuration changes comprise one of a configuration change based on another component's configuration setting, a configuration change based on an enablement of another component's feature, and a configuration change based on a number of instances of another component.

30. The computer system of claim 21, wherein the sending of a configuration change response to the component based on the one or more responses received from the one or more other components comprises sending a reconfiguration notification when the or more other components reject the configuration change.
